(19) United States
(12) Patent Application Publication
(10) Pub. No.: US 2013/0146248 A1
(43) Pub. Date: Jun. 13, 2013

(54) HVAC ASSEMBLY FOR VEHICLE

(71) Applicants: Myung Hoe Kim, Seoul (KR); Jong Heon Lee, Hwaseong-si (KR); Seong Seok Han, Daejeon (KR); Hyung Joo Kim, Daejeon (KR)

(72) Inventors: Myung Hoe Kim, Seoul (KR); Jong Heon Lee, Hwaseong-si (KR); Seong Seok Han, Daejeon (KR); Hyung Joo Kim, Daejeon (KR)

(73) Assignees: Hyundai Motor Company, Seoul (KR); HALLA CLIMATE CONTROL CORP., Daejeon (KR); Kia Motors Corp., Seoul (KR)

(21) Appl. No.: 13/493,328

(22) Filed: Jun. 11, 2012

(30) Foreign Application Priority Data
Dec. 9, 2011 (KR) 10-2011-0131845

(51) Int. Cl. B60H 1/24; B60H 1/00

(52) U.S. Cl. 165/42; 454/162

(57) ABSTRACT

An HVAC assembly for a vehicle is provided that does not require an outward protruding structure so as to form a console vent duct, thus achieving a more compact design, improving a mounting ability on the vehicle, improving a manipulation feeling when selecting each outlet for discharging air, and enhancing sealability between the respective outlets, therefore eventually significantly improving marketability of the vehicle.

### CROSS-REFERENCE TO RELATED APPLICATIONS

The present application claims priority of Korean Patent Application Number 10-2011-0131845 filed Dec. 9, 2011, the entire contents of which application is incorporated herein for all purposes by this reference.

### BACKGROUND OF INVENTION

1. Field of Invention

The present invention relates generally to an HVAC assembly for a vehicle and, more particularly, to an HVAC assembly having a console venting function, intended to blow air to a rear seat of a vehicle.

2. Description of Related Art

FIGS. 1 and 2 show a structure of a conventional heating, ventilating and air conditioning (HVAC) assembly mounted on a vehicle. The HVAC assembly has an evaporator core 500, a heater core 502 and a PTC heater 504 therein, and is provided with a DEF door 512, a vent door 514 and a floor door 516 to supply air, which is blown from a blower and is cooled or heated while passing through the evaporator core 500, the heater core 502 and the PTC heater 504, to a defroster outlet 506, a vent outlet 508 and a floor outlet 510, respectively.

The floor outlet 510 opened by the floor door 516 is connected to a floor duct 518 branching into both sides of a vehicle body. The console vent outlet 508 is formed above the floor outlet 510, so that the console vent outlet 508 is connected to a console vent duct 522 that is defined by a console vent cover 520 attached to a rear of the vehicle at an outside of a central portion of the floor duct 518, thus discharging air from the HVAC assembly to a console vent located at a rear of a console that is positioned between a driver's seat and a passengers' seat.

However, the conventional HVAC assembly configured as described above to supply air from the HVAC assembly to a rear seat is problematic in that the console vent cover 520 should be additionally mounted to form the console vent duct 522, thus causing an increase in material cost and weight, and in addition increasing a width of the HVAC assembly itself at the rear of the vehicle, as a result of which a package ability is poor and a mounting ability on the vehicle is deteriorated.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an HVAC assembly for a vehicle that does not require an outward protruding structure so as to form a console vent duct, thus achieving a more compact design, improving a mounting ability on the vehicle, improving a manipulation feeling when selecting each outlet for discharging air, and enhancing sealability between the respective outlets, therefore eventually significantly improving marketability of the vehicle.

Various aspects of the present invention provide for an HVAC assembly for a vehicle, including an HVAC casing accommodating an evaporator core and a heater core therein, floor outlets open at an upper portion of a rear of the HVAC casing in such a way as to be dividedly provided on both sides thereof, a console vent outlet separately formed between the divided floor outlets, floor ducts formed to communicate with the floor outlets, respectively, thus guiding and discharging air downwards from the floor outlets, and a console vent duct formed to communicate with the console vent outlet between the two floor ducts and to downwardly guide air discharged from the console vent outlet, wherein a vent outlet and a DEF outlet each having an arc-shaped cross-section are sequentially formed in an upper portion of the HVAC casing to be adjacent to the floor outlet and the console vent outlet, and a thin-plate-shaped mode switching door is provided to allow an interior of the HVAC casing to communicate with the floor outlet, the vent outlet or the DEF outlet as the mode switching door slides while coming into contact with an inner surface of the arc-shaped cross-section, with a communicating window formed in the mode switching door.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1 and 2 are views illustrating a structure of a conventional HVAC assembly for a vehicle.

FIG. 3 is an external perspective view illustrating an exemplary HVAC assembly for a vehicle according to the present invention.

FIG. 4 is a view seen from a rear of the HVAC assembly of FIG. 3, and illustrating an internal structure of a floor duct and a console vent duct.

FIG. 5 is a sectional view taken along line V-V of FIG. 3.

FIG. 6 is a sectional view taken along line VI-VI of FIG. 3.

FIG. 7 is a perspective view illustrating an exemplary mode switching door used in an HVAC assembly in accordance with the present invention.

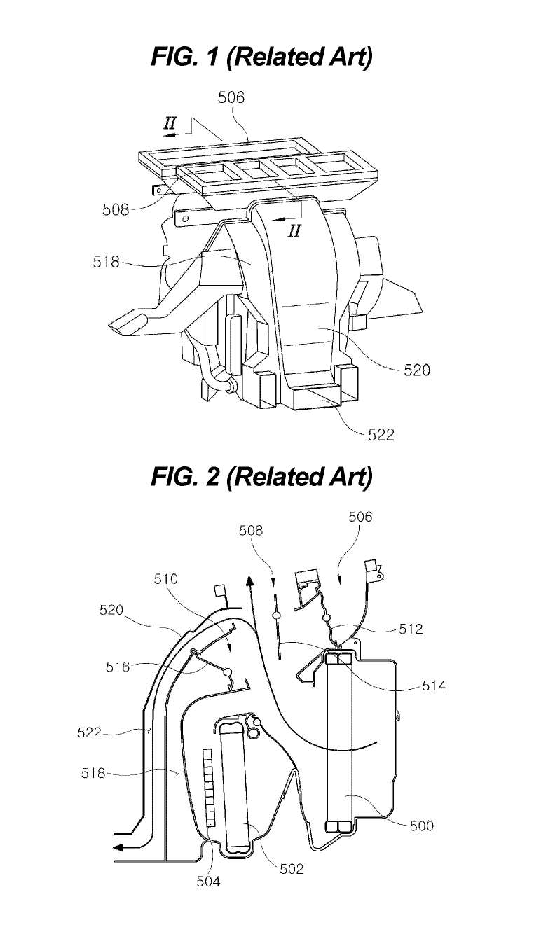

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

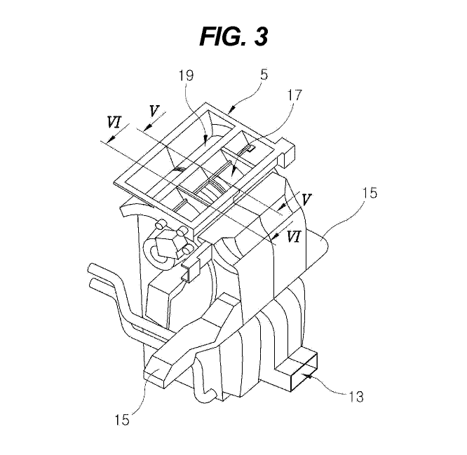

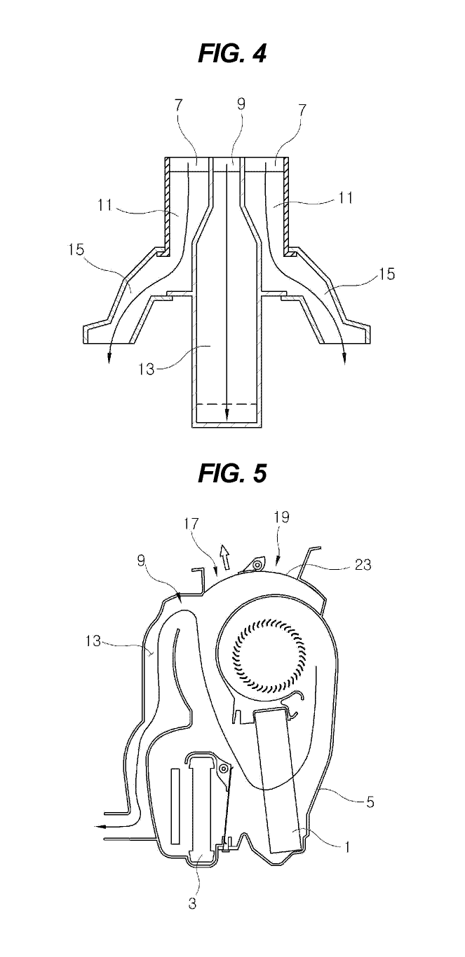

Referring to FIGS. 3 to 7, an HVAC assembly for a vehicle according to various embodiments of the present invention includes an HVAC casing 5, floor outlets 7, a console vent outlet 9, floor ducts 11, and a console vent duct 13. The HVAC casing 5 accommodates an evaporator core 1 and a heater core 3 therein. The floor outlets 7 are open at an upper portion of a rear of the HVAC casing 5 in such a way as to be dividedly provided on both sides thereof The console vent outlet 9 is separately formed between the dividedly provided floor outlets 7. The floor ducts 11 are formed to communicate with the floor outlets 7, respectively, thus guiding and discharging air downwards from the floor outlets 7. The console vent duct 13 is formed to communicate with the console vent outlet 9 between the two floor ducts 11 and to downwardly guide air discharged from the console vent outlet 9.

That is, according to the present invention, the floor ducts 11 and the console vent duct 13 are provided on the rear of the HVAC casing 5. Unlike the conventional HVAC assembly, the console vent duct 13 is placed between the floor ducts 11 while forming the same plane in order to prevent the console vent duct 13 from protruding further rearwards as compared to the floor ducts 11, thus achieving a compact structure even while forming all the floor ducts 11 and the console vent duct 13, therefore remarkably improving a mounting ability on the vehicle.

Particularly, in various embodiments, at a position adjacent to the floor outlets 7 and the console vent outlet 9, the floor ducts 11 and the console vent duct 13 are formed as an integrated passage that is partitioned by an internal partition wall. Thus, this does not require an additional part such as a console vent cover for defining the console vent duct 13 unlike the conventional HVAC assembly, thus reducing a material cost and suppressing an increase of weight, in addition to realizing a more compact structure.

In various embodiments, after the integrated passage extends from the upper portion of the HVAC casing 5 to a midway height, the floor ducts 11 are connected to floor discharge ducts 15 that are flared to opposite sides, and the console vent duct 13 extends further downwards and then is bent rearwards, thus branching into three passages.

Thus, the air discharged through the floor outlets 7 moves downwards through the floor ducts 11 and then is divided into both lower sides through the floor discharge ducts 15. The air discharged through the console vent outlet 9 moves downwards through the console vent duct 13 formed between the floor ducts 11 and then moves to the rear of a vehicle body, so that the air is finally discharged to a rear seat through the console vent provided in the rear of the console.

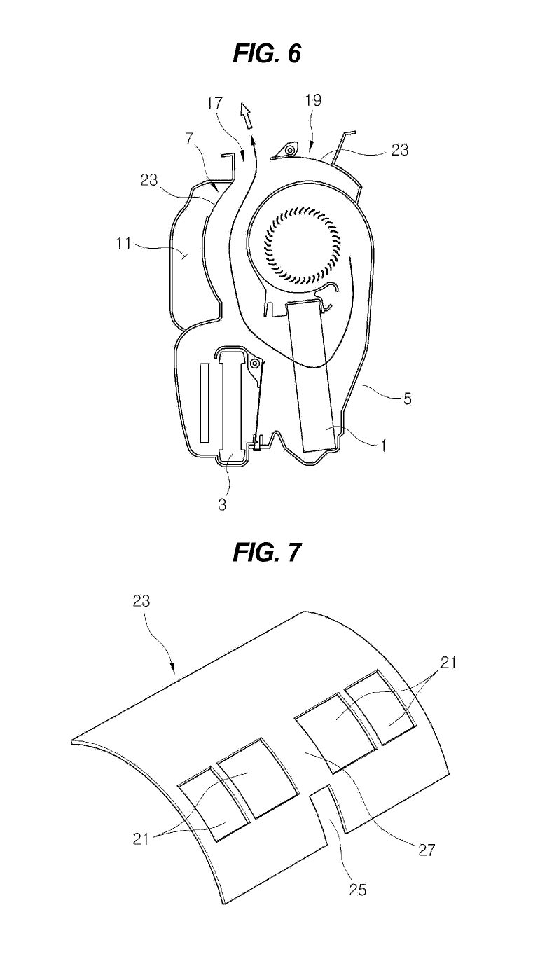

As shown in FIG. 5 or FIG. 6, a vent outlet 17 and a DEF outlet 19 each having an arc-shaped cross-section are sequentially formed in an upper portion of the HVAC casing 5 to be adjacent to the floor outlet 7 and the console vent outlet 9. A thin-plate-shaped mode switching door 23 is provided to allow an interior of the HVAC casing 5 to communicate with the floor outlet 7, the vent outlet 17 or the DEF outlet 19 as the mode switching door slides while coming into contact with an inner surface of the arc-shaped cross-section, with a communicating window 21 formed in the mode switching door.

The mode switching door 23 also has a console vent window 25 that allows the interior of the HVAC casing 5 to communicate with the console vent outlet 9 when the communicating window 21 is aligned with the vent outlet 17.

Further, the communicating window 21 of the mode switching door 23 comprises a plurality of separate windows, and a blocking portion 27 is formed between the communicating windows 21 to close the console vent outlet 9 when the communicating windows 21 are aligned with the corresponding floor outlets 7.

Thus, when the mode switching door 23 slides to align the communicating window 21 with the vent outlet 17, the air present in the HVAC casing 5 is discharged only through the vent outlet 17 and the console vent outlet 9, and the DEF outlet 19 and the floor outlet 7 are in a closed state. Here, the thin plate-shaped mode switching door 23 is brought into close contact with the DEF outlet 19 and the floor outlet 7 by the outwardly acting pressure of the air in the HVAC, thus further improving sealability for the DEF outlet 19 and the floor outlet 7.

Further, when the mode switching door 23 slides to align the communicating window 21 with the floor outlet 7, the air present in the HVAC casing 5 is discharged only through the floor outlet 7, and all of the DEF outlet 19, the vent outlet 17 and the console vent outlet 9 are closed. Likewise, the thin plate-shaped mode switching door is brought into close contact with the outside by the internal pressure of the HVAC casing 5, thus reliably ensuring the sealability.

Furthermore, as described above, the operation of selecting each outlet by operating the mode switching door 23 has only to slide only one thin plate-shaped mode switching door 23, so that operational resistance is relatively small and smooth operation is achieved.

As described above, the present invention provides an HVAC assembly for a vehicle that does not require an outward protruding structure so as to form a console vent duct, thus achieving a more compact design, improving a mounting ability on the vehicle, improving a manipulation feeling when selecting each outlet for discharging air, and enhancing sealability between the respective outlets, therefore eventually significantly improving marketability of the vehicle.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An HVAC assembly for a vehicle, comprising:
an HVAC casing accommodating an evaporator core and a heater core therein;
floor outlets open at an upper portion of a rear of the HVAC casing in such a way as to be dividedly provided on both sides thereof;
a console vent outlet separately formed between the divided floor outlets;
floor ducts formed to communicate with the floor outlets, respectively, thus guiding and discharging air downwards from the floor outlets; and
a console vent duct formed to communicate with the console vent outlet between the two floor ducts, and to downwardly guide air discharged from the console vent outlet,
wherein a vent outlet and a DEF outlet each having an arc-shaped cross-section are sequentially formed in an upper portion of the HVAC casing to be adjacent to the floor outlet and the console vent outlet, and
a thin-plate-shaped mode switching door is provided to allow an interior of the HVAC casing to communicate with the floor outlet, the vent outlet or the DEF outlet as the mode switching door slides while coming into contact with an inner surface of the arc-shaped cross-section, with a communicating window formed in the mode switching door.

2. The HVAC assembly as set forth in claim 1, wherein the floor ducts and the console vent duct form an integrated passage that is partitioned by an internal partition wall at a position adjacent to the floor outlets and the console vent outlet.

3. The HVAC assembly as set forth in claim 2, wherein the floor ducts are connected to floor discharge ducts that are flared to opposite sides, and the console vent duct extends further downwards and then is bent rearwards, thus branching into three passages after the integrated passage extends from the upper portion of the HVAC casing to a midway height.

4. The HVAC assembly as set forth in claim 1, wherein the mode switching door also has a console vent window that allows the interior of the HVAC casing to communicate with the console vent outlet when the communicating window is aligned with the vent outlet.

5. The HVAC assembly as set forth in claim 4, wherein:
the communicating window of the mode switching door comprises a plurality of separate windows; and
a blocking portion is formed between the communicating windows to close the console vent outlet when the communicating windows are aligned with the corresponding floor outlets.

6. The HVAC assembly as set forth in claim 1, wherein the console vent duct is disposed between the two floor ducts while forming the same plane.
